(19) United States
(12) Patent Application Publication
(10) Pub. No.: US 2025/0111077 A1
(43) Pub. Date: Apr. 3, 2025

(54) SYSTEMS AND METHODS FOR MEMBERSHIP DISCLOSURE RISK AWARE SYNTHETIC DATA GENERATION

(71) Applicant: Replica Analytics, Ottawa (CA)

(72) Inventors: Khaled El Emam, Ottawa (CA); Lucy Mosquera, Ottawa (CA); Xi Fang, Ottawa (CA)

(21) Appl. No.: 18/375,608

(22) Filed: Oct. 2, 2023

(51) Int. Cl. G06F 21/62

(52) U.S. Cl. CPC G06F 21/6245

(57) ABSTRACT

Membership disclosure risk for synthetic data can be accurately estimated using a partitioning method using a sampling proportion of records of an attack dataset that are in the real dataset used to generate the synthetic data that is based on a number of records in the real dataset compared to the population size the real dataset is drawn from. The membership disclosure risk can be used to generate synthetic data with an acceptable risk of membership disclosure.

### RELATED APPLICATIONS

The current application claims priority to previously filed U.S. Provisional Application 63/411,783 filed Sep. 30, 2022, the entire contents of which are incorporated herein by reference in its entirety for all purposes.

### TECHNICAL FIELD

The current disclosure relates to providing synthetic data, and in particular to providing synthetic data having an acceptable membership disclosure risk.

### BACKGROUND

There is a growing need to share data in a wide range of contexts, including in health care, artificial intelligence (AI)/machine learning, research among other applications. Depending upon the type of data, the sharing or use of data for secondary purposes may be complicated by privacy concerns. Various approaches to balancing privacy concerns with the sharing and/or use of useful data exist, including patient consent, anonymization of data as well as the use of synthetically generated data. While patient (re-) consent is one legal basis for making data available for secondary purposes, it is often impractical to get retroactive consent under many circumstances and there is significant evidence of consent bias. Anonymization is another approach for addressing privacy concerns when making health data available for secondary analysis. However, there have been repeated claims of successful re-identification attacks on anonymized data, eroding public and regulator trust in this approach.

A general assumption has been that synthetic data has low identity disclosure risks because there is no unique or one-to-one mapping between the records in the synthetic data with the records in the original (real) data. However, there are additional risks beyond identity disclosure that need to be managed for synthetic datasets. If the additional risks are not correctly accounted for, synthetic data may on one hand be shared that is susceptible to privacy attacks, or on the other hand be unnecessarily withheld from being shared or shared in a less useful format.

An additional, alternative and/or improved risk-aware process for generating, evaluating, and/or sharing synthetic data is desirable.

### BRIEF DESCRIPTION OF THE DRAWINGS

Further features and advantages of the present disclosure will become apparent from the following detailed description, taken in combination with the appended drawings, in which:

FIG. 1 depicts a membership disclosure attack on synthetic data;

FIG. 2 depicts a process for evaluating a membership disclosure attack;

FIG. 3 depicts components of a system for synthetic data generation in a membership disclosure risk aware process;

FIG. 4 depicts a method of membership disclosure risk aware synthetic data generation;

FIG. 5 depicts components for training a synthetic data generation model in a membership disclosure risk aware process; and

FIGS. 6-9 depict graphs of simulation results on different datasets.

### DETAILED DESCRIPTION

In accordance with the present disclosure there is provided a method for use in providing a synthetic dataset comprising: receiving at a computing device a real dataset comprising a plurality (n) of records from a population having an estimated population size of N; splitting the real dataset into a training dataset and a holdout dataset; generating an attack dataset by combining m×n/N records from the training dataset and m×(1−n/N) records from the hold out dataset; generating a synthetic dataset from the training dataset using a synthetic data generation process; determining a number of matching records in the attack dataset that match a record in the synthetic dataset; determining a membership disclosure risk score based on the number of matching records; and providing an output at the computing device based on the membership disclosure risk score when the membership disclosure risk score indicates an acceptable level of risk.

In a further embodiment of the method, the method further comprises tuning one or more hyperparameters of the synthetic data generation process when the membership disclosure risk score indicates an unacceptable level of risk.

In a further embodiment of the method, the membership disclosure risk score is based on an F1 score.

In a further embodiment of the method, the membership disclosure risk is an M score determined according to:

$$M = \frac{F - {F}_{ma x}}{1 - {F}_{ma x}} ,$$

where F is the F1 score; and Fₘₐₓ is a maximum F1 score.

In a further embodiment of the method, Fₘₐₓ is determined according to:

$${F}_{m ax} = \frac{2 \times \frac{n}{N}}{1 + \frac{n}{N}} .$$

In a further embodiment of the method, in the M score is used in a loss function for training a model used in the synthetic data generation process.

In a further embodiment of the method, the loss function is determined according to:

$${loss}_{RU} = - max ( [ M > 0.2 ] \times ( 0.31 + \frac{1}{1 + {e}^{( M - 1 )}} ) , [ M \leq 0.2 ] ) \times U ,$$

wherein, U is a utility metric and [ . . . ] are Iverson brackets.

In a further embodiment of the method, the output comprises the trained model used in the synthetic data generation process.

In a further embodiment of the method, an M score of M≤0.2 is used as the membership disclosure risk score that indicates the acceptable level of risk.

In a further embodiment of the method, the output comprises an output dataset generated by the synthetic data generation process.

In a further embodiment of the method, the output dataset comprises the synthetic dataset generated from the training dataset.

In a further embodiment of the method, the output dataset comprises a dataset generated by the synthetic data generation process from the real dataset.

In a further embodiment of the method, determining the number of matching records in the attack dataset that match records in the synthetic dataset comprises comparing each record in the attack dataset to each record in the synthetic dataset to determine if there is a match.

In a further embodiment of the method, a match is determined if a distance between records is less than a matching distance threshold.

In accordance with the present disclosure there is further provided a system for use in providing a synthetic dataset comprising: a processor for executing instructions; and a memory storing instructions which when executed by the processor configure the system to provide any of the methods described above.

In accordance with the present disclosure there is further provided a non-transitory computer readable memory storing instructions which when executed by a processor configure a computing device to provide any of the methods described above.

Membership disclosure is considered an important type of privacy risk for synthetic data and there has been a growing literature on assessing membership disclosure risks for synthetic data. Membership disclosure is when an adversary, using the information in synthetic data, determines that a target individual was included in the real dataset used as input for synthetic data generation. Knowing that an individual was in the real data used to generate the synthetic data can reveal sensitive attributes about that individual if the dataset pertains to a particular disease, condition, or process. The target individual is assumed to be from the same population as the real dataset. For example, if the real dataset pertains to a clinical study of HIV patients, membership disclosure would reveal that the target individual has HIV, or that they had participated in the study. Both would be deemed inappropriate disclosures of private information.

A commonly applied methodology for evaluating membership disclosure is the partitioning method. As described further below, both theoretically and empirically through a simulation on four population datasets, the current parameterizations of the partitioning method, which has used a sampling fraction of 0.5, can either overestimate or underestimate the risk of membership disclosure. The mischaracterization of the risk of a synthetic dataset may result in sharing a dataset that may not preserve privacy as desired or required if the risk is underestimated. Similarly, overestimating the risk can mean that a synthetic dataset which does meet privacy requirements is not shared. As described further below, it is possible to more accurately evaluate the potential membership disclosure risk for a synthetic dataset. The more accurate membership disclosure risk determination can be used to improve the synthetic data generation process. As described further below, the more accurate evaluation may be used when training a synthetic generation model, when generating synthetic data using the synthetic generation model, and/or when evaluating synthetic data that has been generated. The accurate membership disclosure risk evaluation can be used in creating and/or providing improved synthetic data that meets privacy requirements while still providing a high degree of utility.

One of the increasingly accepted methods to evaluate the privacy of synthetic data is by measuring the risk of membership disclosure. This is a measure of the F1 accuracy that an adversary would correctly ascertain that a target individual from the same population as the real data is in the dataset used to train the generative model. This risk has been estimated using a data partitioning methodology with a 0.5 partitioning parameter. The partitioning parameter specifies a proportion of records in an attack dataset that are in the real dataset the synthetic dataset is generated from.

A simulated membership disclosure attack on four population datasets was performed to evaluate the partitioning parameter. The four population datasets were (1) an Ontario COVID-19 dataset, (2) a state hospital discharge dataset, (3) a national health survey, and (4) an international COVID-19 behavioral survey. Two generative methods were evaluated: (1) sequential synthesis and (2) a generative adversarial network. As described further below, a more accurate membership disclosure risk can be provided by using a partitioning parameter that is based on the population size that the real dataset is drawn or sampled from. The 0.5 partitioning parameter previously used in the partitioning method for membership disclosure risk can give quite inaccurate membership disclosure values. The proportion of records from the training dataset in the attack dataset must be equal to the sampling fraction of the real dataset from the population. That is, rather than 0.5 the partitioning parameter should be equal to the number of records in the real dataset divided by the population size the real dataset is drawn from, or an estimation of the population size. The improved results of the approach is demonstrated further below on seven clinical trial datasets. The improved membership disclosure risk evaluation can be incorporated into various systems for training synthetic data generation models, generating synthetic data using a synthetic data generation process, as well as evaluating generated synthetic data.

The notation of Table 1 is used throughout the disclosure.

TABLE 1
The notation used in the disclosure
Datasets

| | |
|---|---|
| R | The real dataset |
| P | The population from which the real dataset is sampled |
| S | Synthetic datasets |
| D | The attack dataset |
| y | A record in the attack dataset (i.e., y ϵ D) |
| y′ | A record in the synthetic dataset (i.e., y′ ϵ S) |
| r | A record in the real dataset (i.e., r ϵ R) |

Dataset Sizes

| | |
|---|---|
| n | The number of records in the real dataset (i.e., n = \|R\|) |
| m | The number of records in the attack dataset (i.e., m = \|D\|) |
| N | The size of the population that R is sampled from (i.e., N = \|P\|) |
| t | The proportion of the attack dataset records that are in the real |
| | dataset |

Hamming Distance

| | |
|---|---|
| L | Hamming distance function |
| h | Hamming distance threshold |

An assessment of membership disclosure is performed by a data custodian before a dataset is released. The data custodian typically does not have access to the population that the real dataset was sampled from, and therefore they use an estimation procedure to determine this disclosure risk. The estimation procedure should accurately reflect the level of success that an adversary performing an attack would achieve on average. If the estimation procedure does not meet that objective, then it would not be useful for decision making with regard to the risk by the data custodian.

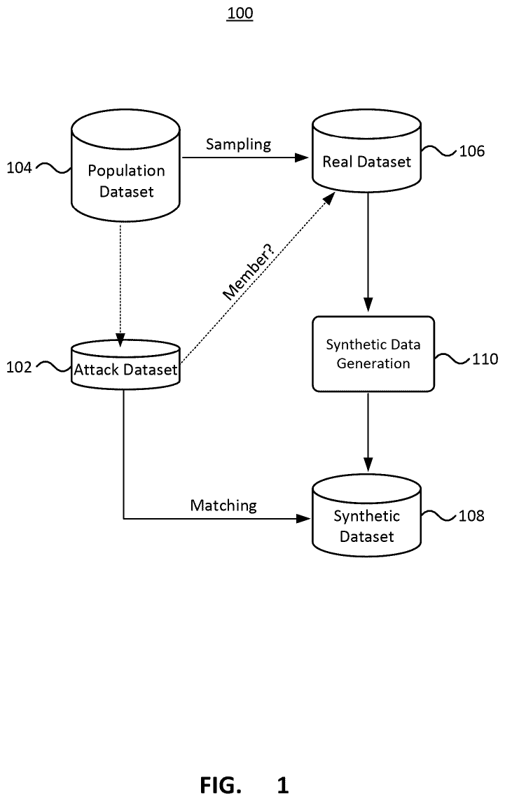

FIG. 1 depicts a membership disclosure attack on synthetic data. Under the partitioning method a membership disclosure attack occurs when an adversary has an attack dataset 102 that is a sample from the same population 104 as the real dataset 106. The attack dataset 102 includes records that will be in the real dataset as well as records that are not in the real dataset. The real dataset 106 is used to generate a synthetic dataset 108 by a synthetic data generation process 110.

The attack dataset consists of one or more target individuals that the adversary intends to compromise. Then the adversary matches records in the attack dataset with records in the synthetic dataset. Membership disclosure occurs when a matching record between the attack dataset and the synthetic dataset is also in the real dataset. A key assumption in this process is that the attack dataset is from the same population as the real dataset, otherwise there is no reason for the adversary to expect that attack dataset records would be in the real dataset.

Because the data custodian does not have access to the actual attack dataset that an attacker would nor the population, the custodian would need to estimate this risk using a different procedure such as a partitioning method as described below. The starting assumption for the partitioning method is that the synthetic data distribution approximates the real dataset distribution. Therefore, the probability that a record in the attack dataset belongs to the training dataset is proportional to the probability that the a record in the attack dataset belongs to the synthetic dataset. The partitioning method does not require a large reference dataset, which explains why it is the most commonly implemented in practice.

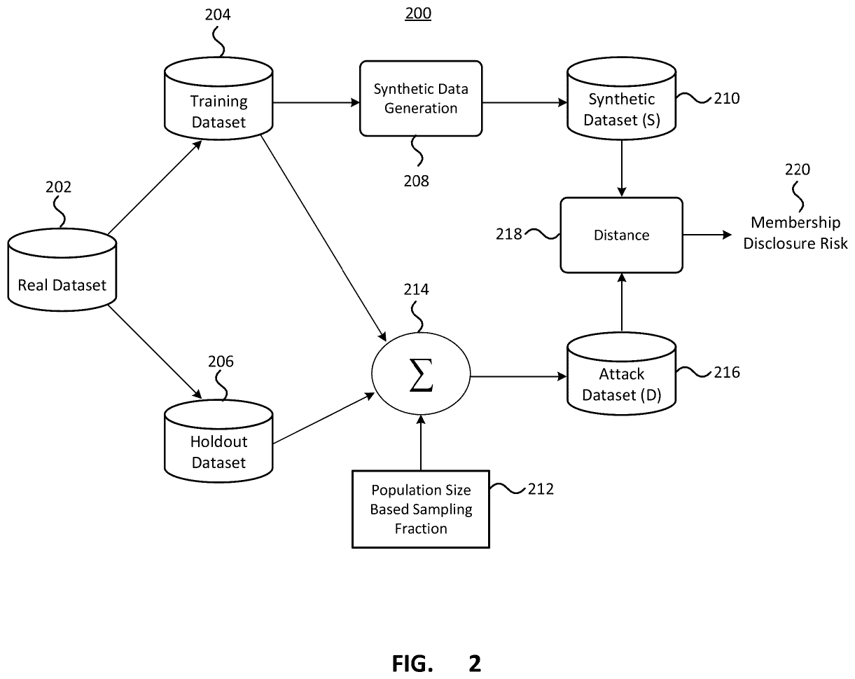

FIG. 2 depicts a process for evaluating a risk of a membership disclosure attack. The process depicted in FIG. 2 is a partitioning based method that with improved accuracy by using a sampling fraction based on the population size. In the partitioning process for evaluating the membership disclosure risk 200, the real dataset 202 is randomly split into two subsets, the training sample 204, and a holdout sample 206. The real dataset does not need to be split evenly between the training and holdout datasets 204, 206. The training sample is then synthesized by a synthetic data generation process 208, and a synthetic dataset 210 is created. The holdout dataset 206 provides records not used in training for inclusion in the attack dataset.

It is assumed that an adversary has complete information on m patients where some are in the training dataset 204 and some are not and so are from the holdout dataset 206. The proportion of the records from the training dataset and holdout dataset in the attack dataset is determined by the population sized based sampling fraction 212, which is represented by t, m×t records are drawn from the training dataset 204 and m×(1−t) records are drawn from the holdout sample 206 and combined together 214 to create the attack dataset 216. For example, if t=0.75 then the attack dataset is ¾ from the training dataset and ¼ from the holdout dataset. m can be set according to m=s×n where s is a sampling fraction from the real dataset. Previous work did not demonstrate a pronounced change when this sampling fraction s was altered.

With the attack dataset and synthetic dataset created, the minimum distance 218 is calculated between every record in the attack dataset, D, and all of the records in the synthetic dataset, S. This distance, L, may be measured using the Hamming distance. A match for attack record y is considered to have occurred if min L(y,y′)≤h, where h is a pre-defined threshold and y′ is a record in the synthetic dataset. The distances and matching threshold can then be used to provide an indication of the membership disclosure risk 220. Precision and recall metrics can be computed based on the number of matched records that are in the training dataset. For example, precision and recall can be computed according to:

$$Precision = \frac{T P}{T P + F P} , \qquad ( 1 )$$

$$Recall = \frac{T P}{T P + F N} \qquad ( 2 )$$

Where:
TP is the number of matched records that are in the training dataset;
FP is the number of matched records that are not in the training dataset; and
FN is the number of unmatched records from the attack dataset that are in the training dataset.

The precision and recall metrics can be combined through their harmonic mean into an F1 score according to:

$$F 1 = \frac{2 \times Precision \times Recall}{Precision + Recall} \qquad ( 3 )$$

An advantage of the F1 score is that it provides a single metric that can be used for decision making and optimization during the training of the generative model, generating synthetic data, and/or evaluating generated synthetic data. The F1 score computed using this method is an estimate of the expected success that an adversary would have when performing a membership disclosure attack on the synthetic data.

In contrast to previous partitioning techniques that used a sampling proportion (t) of 0.5, as described further below, improved accuracy is provided in the membership disclosure risk evaluation when the value of t is based on the population size and the size of the real dataset drawn from the population. The value of t described below is consistent with the sample that an adversary would obtain when constructing an attack dataset, irrespective of the size of the attack dataset. The independence of the evaluation method from the size of the attack dataset can be beneficial as a data custodian is likely to not know the size of the attack dataset when evaluating the membership disclosure risk.

The real dataset is a set of records R of size n=|R| and a synthetic version is generated from the real dataset with the synthetic dataset denoted by the set of records S. The attacker has another dataset represented by D which is the attack dataset, and m=|D|. Both R and D are independent random samples from the same population, which is the set of records P, with N=|P| which is the size of the population.

With the above setup, the probability that there are k individuals in the overlap of R and D, such that k=|R∩D|, can be expressed as a hypergeometric distribution:

$$p r ( k = x ) = \frac{( \begin{matrix}N - m \\ n - x\end{matrix} ) ( \begin{matrix}m \\ x\end{matrix} )}{( \begin{matrix}N \\ n\end{matrix} )} \qquad ( 4 )$$

The hypergeometric distribution of equation (4) has an expected value of mn/N. The proportion of individuals from the attack dataset that can plausibly exist in the real dataset is therefore n/N, which is the same as the sampling fraction of the real dataset from the population.

Accordingly, an adversary sampling an attack dataset from the same population as the real dataset will have an expected proportion of t=n/N of records in the attack dataset that are also in the real dataset. For the data custodian to correctly assess the membership disclosure risk, that same proportion of records from the real dataset that the adversary will have should be used to give a correct estimate of the F1 score. As such, when evaluating a membership disclosure risk using a partitioning for a synthetic dataset generated from a real dataset that is sampled from a population the partitioning fraction, t, should be t=n/N.

An actual membership disclosure adversary attack on synthetic datasets was evaluated to provide a ground truth of the F1 success rate. This ground truth simulation assumes that the adversary samples 1000 records randomly from the population and matches these records with the synthetic records. Any records from the attack dataset that match synthetic records are claimed to also be in the training dataset and the F1 score for the attack can be computed. Matching between records does not need to be an exact match and may be evaluated using one or more techniques such as calculating a Hamming distance between two records with the records considered to match if the distance is within a threshold value. This process models the adversary behavior of the membership disclosure attack as defined in the literature.

The membership disclosure risk of the synthetic data is then estimated using the partitioning method depicted in FIG. 2 with the partitioning fraction determined based on the population size according to varying values of t between 0 and 1. The estimated membership disclosure risk is then compared to the ground truth F1 scores.

The two approaches, namely the ground truth evaluation and the partitioning estimate, are then compared to determine when they give the same results, that is at what value of t are the F1 score values the same. This is the value of t that should be used when computing membership disclosure using the partitioning method since that is the value which gives the same result as the ground truth.

For these simulations, 50 iterations were ran for each study point where the parameters were as follows: (a) the t parameter was varied randomly from 0 to 1, (b) the size of the attack dataset was fixed at 1000 observations, since when this parameter was varied it had no impact on the results as long as there were sufficient observations to get a stable value for F1, (c) the training dataset size was set to 5k, 15k, and 25k, (d) the Hamming distance threshold was set to 5 which is within the range of values commonly used in the literature, (e) two generative models were used, and (f) four different datasets.

The first type of generative model used for generating the synthetic data was a sequential tree-based synthesizer. This has been used to synthesize health and social sciences data, and applied in research studies on synthetic data. The second is CTGAN, which is a generative adversarial network (GAN) architecture. GANs have been applied often for the synthesis of health data. These two types of generative models are representative of those used in practice for generating synthetic data.

Four datasets were used as the population in the simulations, which are summarized in tables 2-5 below. These datasets were selected as they reflect heterogeneous data collection contexts including care settings, public health, and surveys. They also vary in data complexity. The dataset sizes were set so that there is realistic variation in the sampling fractions of the real datasets that were used.

TABLE 2
Ontario COVID-19 Case dataset

| Variable | Definitions |
|---|---|
| Date Reported | Number of days since 1 Jan. 2020; this variable |
| | was discretized into 20 groups |
| Health Region | 34 unique regions |
| Age Group | Decades from 20 to 80+ (ordinal) |
| Gender | Binary gender |
| Exposure | close contact, outbreak, travel, not reported |
| Case Status | recovered, deceased, active |

TABLE 3
Washington state hospital discharge database

| Variable | Definitions |
|---|---|
| AGE | Patient age in years |
| AMONTH | Admission month |
| AWEEKEND | Weekend admission (Y/N) |
| DIED | Whether the patient died |
| FEMALE | Sex |
| LOS | Length of stay |
| ZIP | Patient ZIP code |
| AYEAR | Admission year (2006 or 2007) |

TABLE 4
The Canadian Community Health Survey data

| Variable | Definitions |
|---|---|
| LBSG31 | Employment status over the last 12 months |
| | (full/part time) |
| SMKDSTY | Type of smoker |
| GEOGPRV | Province of residence |
| DHHGAGE | Age (category) |
| DHH_SEX | Sex |
| DHHGMS | Marital status |
| DHHGLVG | Living arrangements |
| DHHGHSZ | Household size |
| GEN_08 | Worked in a job or business over last 12 months |
| LBSGSOC | Occupation group |
| EDUDH04 | Highest level of education |
| SDC_8 | Current student |
| SDCFIMM | Immigrant or not |
| SDCGCGT | Cultural or racial origin |

TABLE 5
the Nexoid COVID-19 behavioral survey

| Variable | Definitions |
|---|---|
| survey_date | Date survey was administered |
| country | Country of residence of the respondent |
| sex | Sex |
| age | Age in years |
| height, weight, | Height (cm), weigh (kg), and BMI |
| bmi | |
| blood_type | Blood type or “unknown” |
| smoking | Amount of cigarettes smoked |
| Drugs (x6) | Drugs that the respondent may be taking |
| risk_infection | Calculated risk of infection with COVID-19 |
| Risk_mortality | Calculated mortality risk from COVID-19 |

The F1 score is known to depend on the distribution of positive classes, which in the current case is the proportion of real records in the attack dataset. This means that the F1 value by itself will not have a consistent interpretation across different datasets with varying distributions. Accordingly, the obtained F1 score is interpreted relative to the maximum that the adversary would obtain with no background knowledge about the real dataset. The highest F1 score that can be obtained by the adversary with no background knowledge would be if they classify all of the records in the attack dataset as being in the real dataset. This value would be obtained irrespective of any synthesis method used as its only assumption is that the adversary has drawn a sample of targets from the same distribution as the training dataset and does not depend on the availability of a synthetic dataset. In such a case the maximum F1 score from classifying all records in the attack dataset as being in the real dataset would be:

$${F}_{max} = \frac{2 \times n / N}{1 + n / N} , \qquad ( 5 )$$

$$As t = n / N \to 0 , {F}_{max} \to 0 , and when t = n / N = 1 , {F}_{max} = 1 .$$

This maximum F1 score is a function of the proportion of the population that is in the real dataset. The larger that proportion the greater the success of the adversary by using this naïve strategy. That is not surprising in that the more individuals in the real dataset, claiming that a randomly selected person from the population is in the training dataset is more likely to be correct.

Note that if the adversary randomly assigns attack records to a training dataset based on a probability of 0.5, their F1 score would be lower than equation (5). Therefore, there is no reason for an adversary to follow that sub-optimal approach.

The naïve maximum value in equation (5) will be the case even if another privacy enhancing technology was used instead of synthetic data generation. For example, if risk-based de-identification methods were used the maximum F1 score from a naïve membership disclosure attack would be the same. Under this naïve attack recall is by definition equal to 1 and precision is equal to n/N.

The F1 score produced using the partitioning method can be interpreted with respect to this maximum value. A corrected F1 score is defined to reflect membership disclosure risk that is similar in construction to other metrics such as Cohen's Kappa, and denote it with M:

$$M = \frac{F - {F}_{max}}{1 - {F}_{max}} , \qquad ( 6 )$$

M is undefined when Fₘₐₓ=1 since no additional improvements are possible. Previous researchers have used a 20% improvement over a naive baseline as an acceptable threshold for membership disclosure risk for synthetic data, and a similar cutoff is used in the current evaluation. In such a case an acceptable membership disclosure risk is defined as M<0.2. If the M value is negative then the adversary actively matching the attack dataset with the synthetic dataset would produce results worse than the naïve approach which means that using the synthetic dataset in a membership disclosure attack reduces the relative success of the adversary.

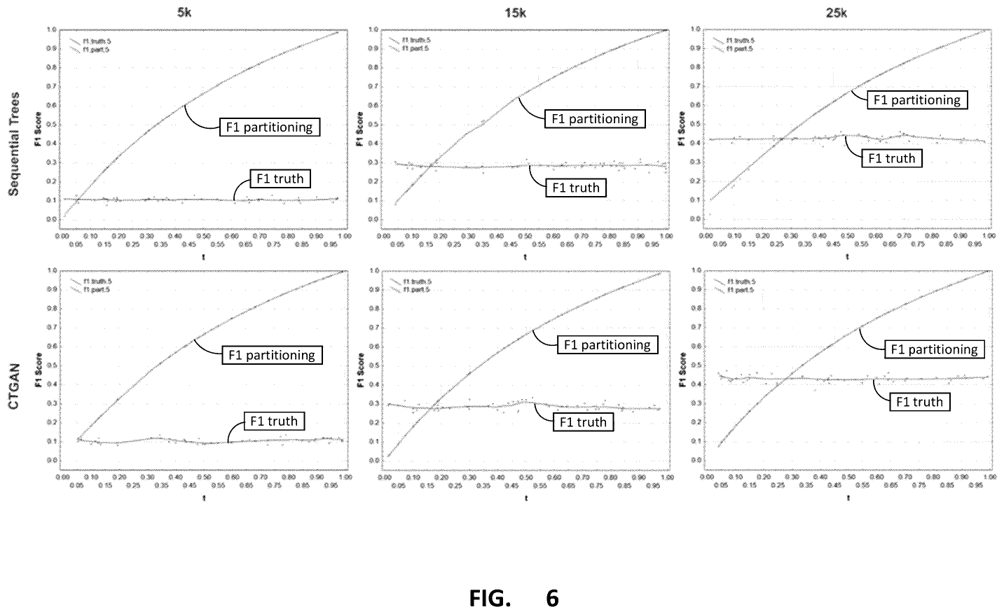

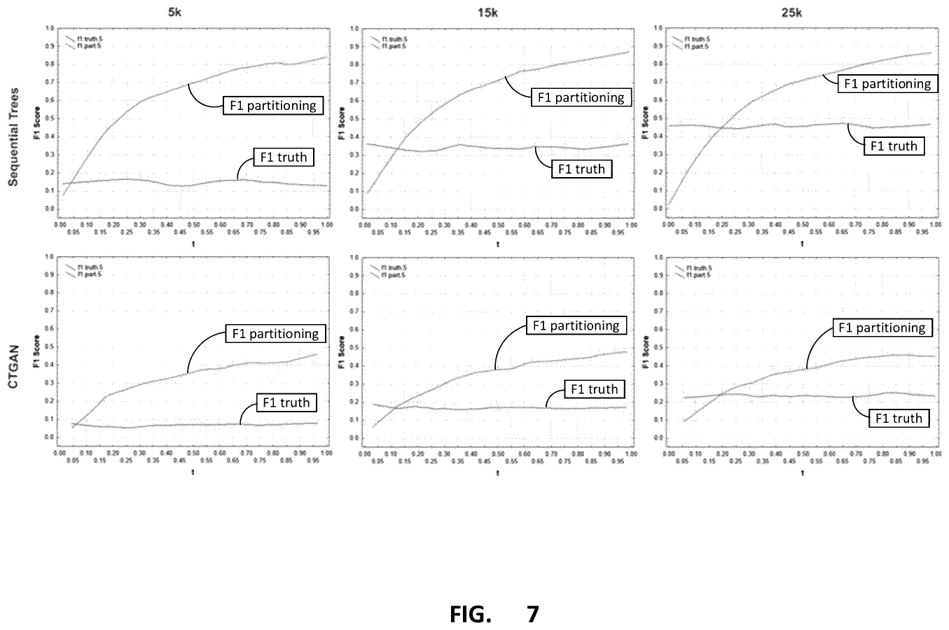

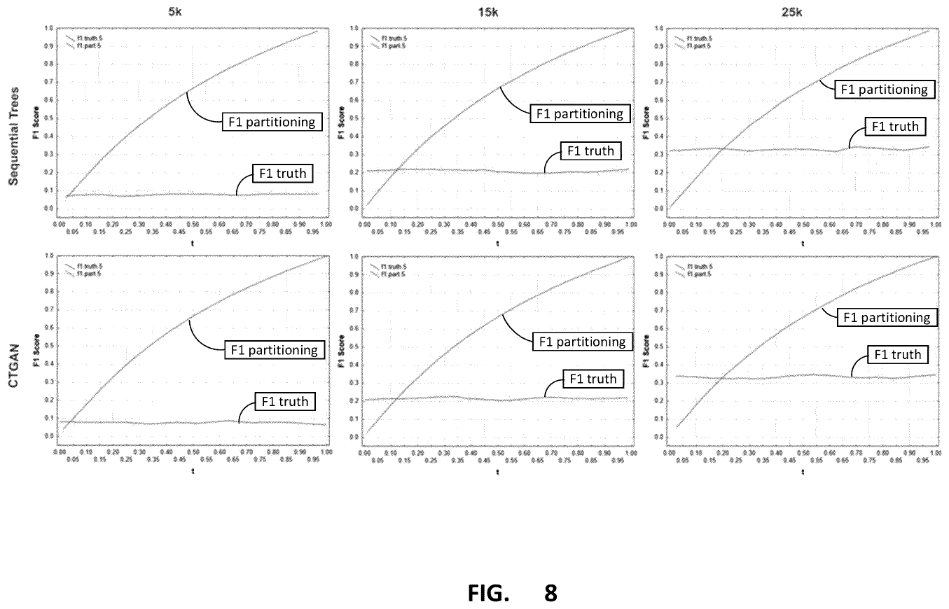

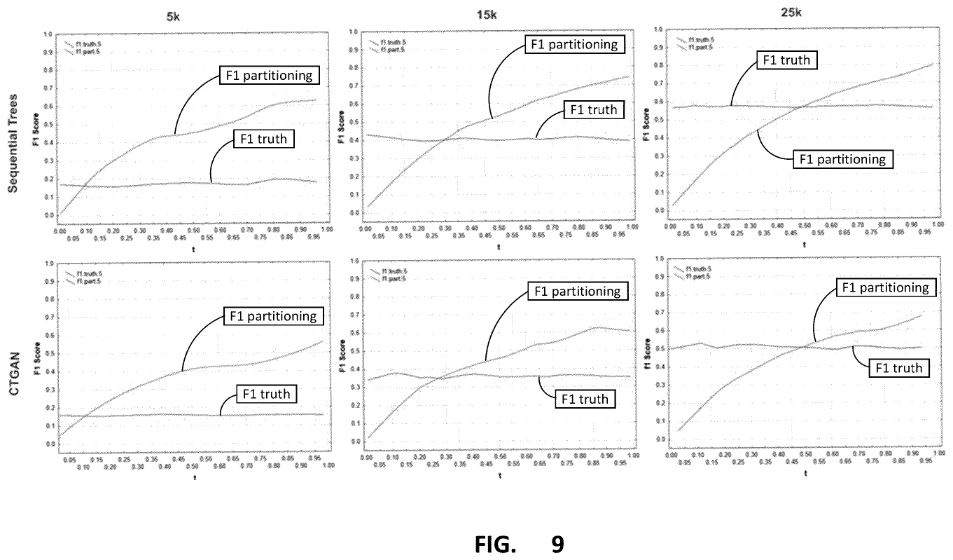

The results are depicted in the graphs FIGS. 6-9. FIG. 6 depicts the results for the COVID dataset. FIG. 7 depicts the results for the Washington dataset. FIG. 8 depicts the results for the CCHS dataset. FIG. 9 depicts the results for the Nexoid dataset. The plots show the F1 score using the partitioning method as the t value is varied with the matching threshold h=5. The ground truth F1 score based on a simulation of a membership disclosure attack by an adversary is relatively fixed across iterations since it is not affected by the value of t.

The results show that the t value for the partitioning method has a non-trivial impact on the F1 score. The F1 values vary significantly across the range of t. Further, the partitioning method for evaluating the membership disclosure risk only gives the same F1 score as the ground truth when t=n/N, which is where the two lines in the plots intersect. Setting t=0.5 as in the prior art does not reliably give the correct estimates of the actual membership disclosure F1 score, and sometimes the error can be quite large. Depending on whether the real data sampling fraction is above or below the t=n/N point, the F1 score of the partitioning method can be substantially higher than or lower than the ground truth value, and as such the estimate of the membership disclosure risk for a synthetic dataset can be substantially incorrect. These results are consistent across the datasets, generative models, and dataset sizes.

An adversary with a random sample of target individuals from the population will not achieve t=0.5 all the time and therefore always using that value will not reliably give a true reflection of the performance of an adversary attack.

To further demonstrate that the parameterization of the partitioning method for more reliable risk estimation is t=n/N, the mean values of the F1 score from the ground truth simulation and another simulation with t=n/N are depicted in Table 6. The simulations used the same number of iterations. As can be seen, the F1 score is very similar between the two simulations, further supporting the conclusion that this is a reliably accurate reflection of the performance of a membership disclosure attack.

The M values for the three dataset sizes are shown in Table 7. All the values are below the threshold value M<0.2. The specific membership disclosure value is a function of the combination of dataset complexity and the generative model that is used.

TABLE 6
the simulated ground truth F1 values versus the F1 values estimated using
the partitioning method with t = n/N and dataset sizes of 5k, 15k and 25k.

| | Sequential Trees | | | | | | CTGAN | | | | | |
|---|---|---|---|---|---|---|---|---|---|---|---|---|
| | 5k | | 15k | | 25k | | 5k | | 15k | | 25k | |
| | Act. | Est. | Act. | Est. | Act. | Est. | Act. | Est. | Act. | Est. | Act. | Est. |
| Dataset | F1 | F1 | F1 | F1 | F1 | F1 | F1 | F1 | F1 | F1 | F1 | F1 |
| COVID | 0.105 | 0.104 | 0.283 | 0.283 | 0.426 | 0.432 | 0.104 | 0.104 | 0.28 | 0.284 | 0.431 | 0.432 |
| Washington | 0.146 | 0.148 | 0.34 | 0.334 | 0.456 | 0.454 | 0.066 | 0.07 | 0.168 | 0.169 | 0.235 | 0.24 |
| CCHS | 0.077 | 0.075 | 0.21 | 0.2 | 0.329 | 0.327 | 0.076 | 0.075 | 0.214 | 0.211 | 0.33 | 0.327 |
| Nexoid | 0.169 | 0.174 | 0.402 | 0.4 | 0.568 | 0.564 | 0.156 | 0.159 | 0.358 | 0.36 | 0.507 | 0.502 |

TABLE 7
mean M results on 50 iterations for the four datasets
and dataset sizes of 5k, 15k and 25k.

| | Sequential Trees | | | CTGAN | | |
|---|---|---|---|---|---|---|
| Dataset | 5k | 15k | 25k | 5k | 15k | 25k |
| COVID | −0.0002 | −0.0009 | −0.001 | −0.0002 | −0.0006 | −0.0009 |
| Washington | 0.08 | 0.159 | 0.192 | −0.003 | −0.049 | −0.122 |
| CCHS | −0.0002 | 0.0003 | −0.0001 | <−0.0001 | 0.0001 | −0.0001 |
| Nexoid | −0.009 | −0.114 | −0.305 | −0.027 | −0.184 | −0.492 |

Membership disclosure is considered an important privacy risk for synthetic data, and needs to be evaluated before such datasets can be used and disclosed for secondary purposes. The partitioning method for estimating membership disclosure makes reasonable assumptions about the information that an adversary has access to and is often used in the literature. The partition method splits the real dataset into a training dataset and a holdout dataset. The training dataset is used to generate the synthetic data. An attack dataset is constructed with a certain proportion of it from the training dataset, and the rest from the holdout. The default in the literature is a proportion of 0.5. Then a matching exercise between the attack and synthetic dataset is performed matches are predicted to be in the training dataset, and the accuracy of that prediction is evaluated using an F1 score. As shown above, the partitioning proportion of 0.5 does not reliably give an accurate estimate of the membership disclosure risk. Using a partitioning proportion of t=n/N in the partitioning method provides a reliably accurate estimate of the disclosure risk.

The simulations performed show that the proportion of training records included in the attack dataset has a nontrivial impact on the accuracy of the F1 score, and to give valid results this proportion must be equal to the sampling fraction of the real dataset from the population. If this condition is not met the F1 score can be quite inaccurate and does not reflect the results that an adversary would obtain in practice.

As described further below, an interpretable adjustment of F1 score computed through this approach can be implemented to generate synthetic data, train a synthesis model and/or evaluate synthetic data in a membership disclosure risk aware manner. This enables data custodians to determine whether their membership disclosure values are acceptably small or not, which in turn can allow the data custodian to more reliably share synthetic data while still adhering to privacy requirements. In order to determine the partitioning proportion t for the partitioning method, it is necessary to provide a value for the population size. This can be estimated in various ways, including for example based on the prevalence of a disease in a particular geography.

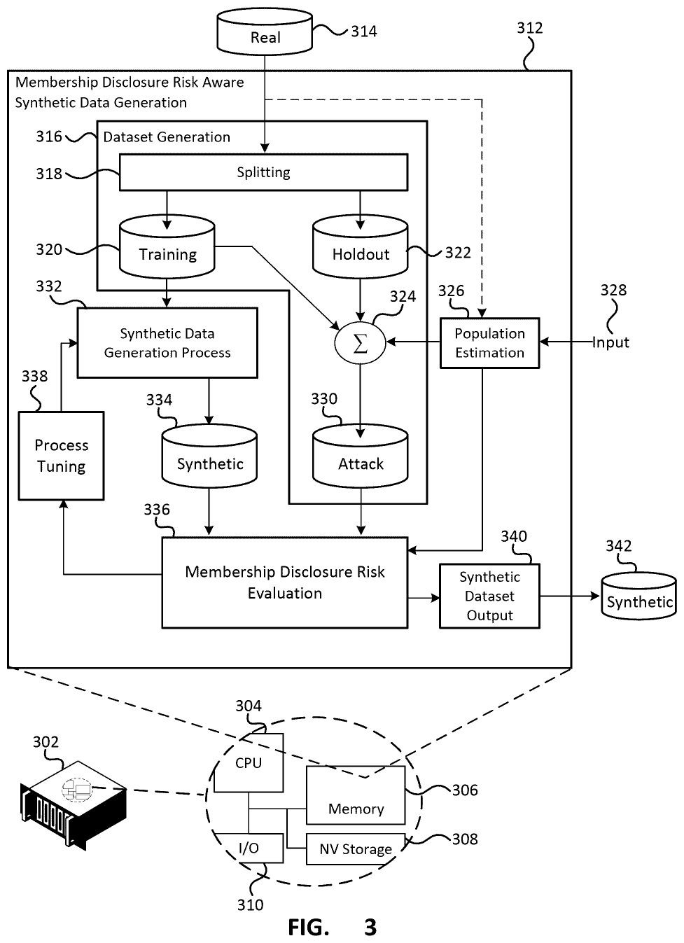

FIG. 3 depicts components of a system for synthetic data generation in a membership disclosure risk aware process. The system 302 is depicted as a single computing device; however, it will be appreciated that the system may comprises a plurality of computing devices communicatively coupled together. The system 302 is depicted as comprising a central processing unit (CPU) 304 that executes instructions in order to configure the system 302 to perform various functionality. The instructions may be stored in memory 306 and/or in non-volatile storage 308. One or more input/output (I/O) interfaces 310 may allow various input and/or output devices to be coupled to the CPU. The functionality that is configured by the execution of the instructions may include membership disclosure risk aware synthetic data generation functionality 312, which is based on the partitioning method described above that uses the more reliable partitioning parameter of t=n/N. The data generation functionality 312 receives a real dataset 314 that is to be used to generate corresponding synthetic data from. The real dataset 314 is sampled from some population having a particular size. Dataset generation functionality 316 receives the real dataset and splitting functionality 318 splits the real dataset into a training dataset 320 and holdout dataset 322. The training dataset and holdout dataset are combined by combining functionality 324. The combining functionality 324 samples records from the training dataset and holdout dataset according to a sampling proportion. The sampling proportion is determined based on the number of records in the received real dataset 314, depicted by the dashed arrow, and a population estimation 326. The population estimation may be provided directly from an input 328 of the data custodian, or the population estimation may be determined in various other ways which may include evaluating information about the real dataset and combining with other external information. As an example, the information about the real dataset may be an indication that the dataset is about patients in a geographic region with a certain condition and the external information may be information about the prevalence of the condition in the population of the geographic region and the population size of the geographic region. The population estimate is used with the real dataset size in order to define the sampling fraction used by the combining functionality according to t=n/N. The combining functionality samples the training and holdout datasets according to the sampling fraction in order to generate the attack dataset. The sampling functionality samples m×t records from the training dataset and m×(1−t) records from the holdout sample to combine into the attack dataset. The number of records in the attack dataset may be varied, including by setting the number of records according to m=s×n, where s is a sampling fraction of the real dataset and n is the number of records in the real dataset. As noted above, s does not greatly impact the reliability of the risk estimation.

The data generation process uses a synthetic data generation process 332 in order to generate a synthetic dataset 334 from the training dataset 320. The synthetic data generation process may be for example a sequential tree generation process, a generative adversarial network (GAN) process, or other processes for generating synthetic data. With the synthetic dataset and the attack dataset, the risk can be evaluated as described above. Membership disclosure risk evaluation functionality 336 can determine matches between records in the attack dataset and the synthetic dataset. An F1 score can be computed, and possibly an M score, as described above using the sampling fraction based on the population estimate according to t=n/N. The F1 score and/or the M score can be used to determine if the membership disclosure risk of the synthetic data is acceptable, which when using the M score, may be M<0.2. When the membership disclosure risk is not acceptable, the synthetic generation process may be tuned 338 and the synthetic dataset 334 re-generated using the tuned process. The tuning may comprise adjusting one or more parameters of the synthetic data generation process. The re-generated synthetic dataset can again be evaluated by the membership disclosure risk evaluation functionality 336. If the membership disclosure risk is acceptable, synthetic dataset output functionality 340 may output a synthetic dataset 342. The synthetic dataset output functionality 340 may output the synthetic dataset 334. Additionally or alternatively, the synthetic dataset output functionality may generate a new synthetic dataset with the same synthetic data generation process however using the entire real dataset rather than just the training dataset.

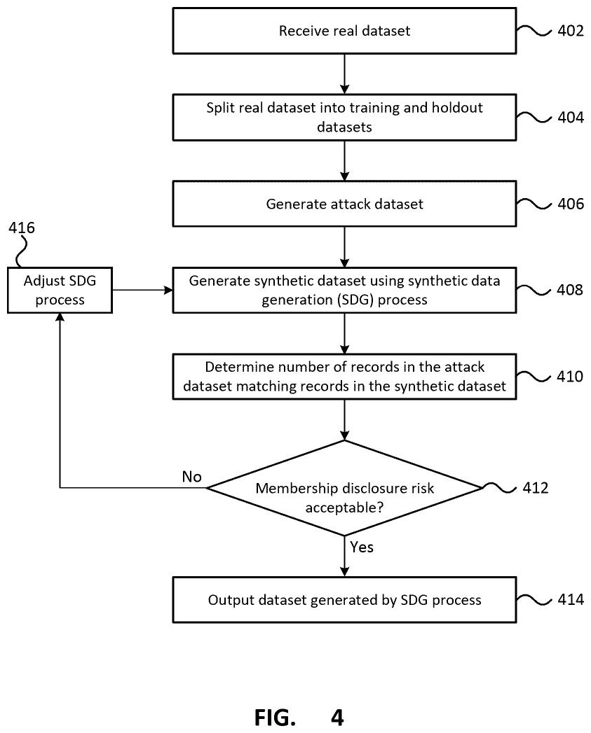

FIG. 4 depicts a method of membership disclosure risk aware synthetic data generation. Executing by one or more computing devices instructions can configure the one or more computing devices to perform the method 400. The method comprises receiving a real dataset (402). The real dataset comprises a plurality of data records that are sampled or drawn from a population. The population that the real dataset are from has a particular size. The real dataset is split into a training dataset and a holdout dataset (404). The split may be done by randomly sampling the real dataset to draw records for the training dataset and the holdout dataset. The real dataset does not need to be evenly split between the training and holdout datasets. Once the datasets are split, an attack dataset is generated (406). The attack dataset is generated by combining records from the training dataset and the holdout dataset according to the sampling fraction of t=n/N. The attack dataset may comprise m×t records from the training dataset and m×(1−t) records from the holdout dataset. The number of records in the attack dataset may be varied, including by setting the number of records according to m=s×n, where s is a sampling fraction of the real dataset. Generating the attack dataset may further including receiving or generating an estimate of the population size that the real dataset is drawn from. The size of the real dataset can be determined directly from the received dataset as the total number of records.

In addition to generating the attack dataset, a synthetic dataset is also generated. The synthetic dataset may be generated, before, during and/or after the attack dataset is generated. The synthetic dataset may be generated according to a synthetic data generation process (408) that may be based on, for example, sequential trees, and/or GANs. Once records of both the synthetic dataset and attack dataset are available, they can be compared to determine the number of records in the attack dataset that match records in the synthetic dataset (410). Matching between records can be based on various metrics including a Hamming distance between the records. If a Hamming distance is below a threshold distance two records may be considered as matching. Based on the number of matched records, a membership disclosure risk may be determined. For example, an F1 score, and/or an M which provides an F1 score relative to a maximum possible F1 score, can be determined. It is determined if the membership disclosure risk is acceptable (412), which may be for example when M<0.2. If the membership disclosure risk is acceptable (Yes at 412), a synthetic dataset that was generated by the synthetic data generation process can be output (414). The output synthetic dataset may be the previously generated synthetic dataset used in evaluating the membership disclosure risk, or may be a synthetic dataset generated by applying the entire received real dataset to the synthetic data generation process. If the membership disclosure risk is not acceptable (No at 412), the synthetic data generation process may be adjusted (416) and the synthetic dataset generated again according to the adjusted process (408).

The membership disclosure metric described above was used to evaluate the membership disclosure risk on seven oncology clinical trial dataset. Given the increasing interest in making clinical trial datasets available, the objective was to determine what the privacy risks would be for synthetic variants, and whether these risks would be deemed acceptably small. The seven datasets that were examined are from Project Data Sphere.

The population was defined as other similar trials, which is consistent with Health Canada recommendations for defining the reference population in privacy risk assessments. For each trial, other trials in the same therapeutic area over the same period and with overlapping geographies were identified from existing clinical trials searchable at https://ClinicalTrials.gov. The sequential synthesis method was used to synthesize these trial datasets.

As can be seen from the results in Table 8 the membership disclosure risks are consistently below the threshold described above. This suggest that in a system and/or method as described above, sequential synthesis can be a useful generative approach for protecting the membership disclosure risks of oncology clinical trial datasets, and enable their broader sharing within the research community. This may be appealing given that previous results have shown that sequential synthesis can have good utility for oncology clinical trial data and for observational datasets.

This example application demonstrates how the population size was determined for clinical trial datasets and used in evaluating the membership disclosure risk. In the general context of disclosure risk estimation models, it is common to have to provide a population size value. In cases where determining the population size is not obvious, one default option is to use the geographic population size for the region that is covered by the dataset. If the population size is underestimated then that results in an overestimation of membership disclosure risk, and if the population size is overestimated then that results in an underestimation of membership disclosure risk. Therefore, to err on the conservative side it is preferable to use a lower value for the population size when there is uncertainty. In the case of the default option for determining population size, this means selecting the smallest region that covers a dataset.

TABLE 8
Summary of the oncology trials used

| | | |
|---|---|---|
| | Population | |
| | size | |
| | (dataset | |
| Dataset | size) | M |

Trial #1 (NCT00041197): National Cancer Institute

| | | |
|---|---|---|
| Tests if post-surgery receipt of imatinib could reduce the recurrence of | 1,310 | −1.42 |
| Gastrointestinal stromal tumors (GIST). Imatinib is an FDA approved protein- | (n = 773) | |
| tyrosine kinase inhibitor for treating certain cancers of the blood cells. This drug | | |
| is hypothesized to be effective against GIST as imatinib inhibits the kinase which | | |
| experiences gain of function mutations in up to 90% of GIST patients. At the time | | |
| of this trial the efficacy of imatinib for GIST as well as the optimal dosage for | | |
| treatment of GIST was unknown. | | |

Trial #2 (NCT01124786): Clovis Oncology

| | | |
|---|---|---|
| Most pancreatic cancer patients have advanced inoperable disease and | 19,255 | −0.0137 |
| potentially metastases. At the time of this trial the first line therapy for patients | (n = 367) | |
| with inoperable disease was gemcitabine monotherapy. One transporter (hENT1: | | |
| human equilibrative nucleoside transporter-1) has been identified as a potential | | |
| predictor of successful treatment via gemcitabine. | | |
| This trial compares standard gemcitabine therapy to a novel fatty acid derivative | | |
| of gemcitabine. This is hypothesized to be superior to gemcitabine in metastatic | | |
| pancreatic adenocarcinoma patients with low hENT1 activity as it exhibits | | |
| anticancer activity independent of nucleoside transporters like hENT1, while | | |
| gemcitabine seems to require nucleoside transporters for anticancer activity. | | |

Trial #3 (NCT00688740): Sanofi

| | | |
|---|---|---|
| This phase 3 trial compares adjuvant anthracycline chemotherapy | 21,875 | −0.034 |
| (fluorouracil, doxorubicin, and cyclophosphamide) with anthracycline taxane | (n = 746) | |
| chemotherapy (docetaxel, doxorubicin, and cyclophosphamide) in women with | | |
| lymph node positive early breast cancer. | | |

Trial #4 (NCT00113763): Amgen

| | | |
|---|---|---|
| This was a randomized Phase 3 trial examining whether panitumumab, when | 58,381 | −0.0137 |
| combined with best supportive care, improves progression-free survival among | (n = 370) | |
| patients with metastatic colorectal cancer, compared with those receiving best | | |
| supportive care alone. Patients included in the study had failed other | | |
| chemotherapy options available at the time of the study. Participants were | | |
| enrolled between 2004 and 2005. | | |

Trial #5 (NCT00460265): Amgen

| | | |
|---|---|---|
| This was also a randomized Phase 3 trial on panitumumab, but among patients | 5,868 | −0.0947 |
| with metastatic and/or recurrent squamous cell carcinoma of the head and | (n = 520) | |
| neck. The treatment group received panitumumab in addition to other | | |
| chemotherapy (Cisplatin and Fluorouracil), while the control group received | | |
| Cisplatin and Fluorouracil as first line therapy. Participants were enrolled | | |
| between 2007 and 2009. | | |

Trial #6 (NCT00119613): Amgen

| | | |
|---|---|---|
| This was a randomized and blinded Phase 3 trial aimed at evaluating whether | 16,484 | −0.0322 |
| “increasing or maintaining hemoglobin concentrations with darbepoetin alfa” | (n = 479) | |
| improves survival among patients with previously untreated extensive-stage | | |
| small cell lung cancer. The treatment group received darbepoetin alfa with | | |
| platinum-containing chemotherapy, whereas the control group received placebo | | |
| instead of darbepoetin alfa. | | |

Trial #7 (N0147): NCCTG

| | | |
|---|---|---|
| This was a randomized trial of 2,686 patients with stage 3 colon adenocarcinoma | 27,526 | 0.052 |
| that were randomly assigned to adjuvant regimens with or without Cetuximab. | (n = 1543) | |
| After resection of colon cancer, Cetuximab was added to the modified sixth | | |

The summary of the oncology trials used on the analysis are shown in Table 8 along with the study size and the population, as well as the membership disclosure risk (M). The population includes the specific study participants. The n value indicates the number of trial participants for which data was available.

The above has described a process in which a synthetic dataset can be generated from a real dataset in a membership disclosure risk aware manner. While the process described above can be applied to a wide range of datasets, as described further below, it is possible to incorporate the risk assessment into the training process of the model used to generate the synthetic data.

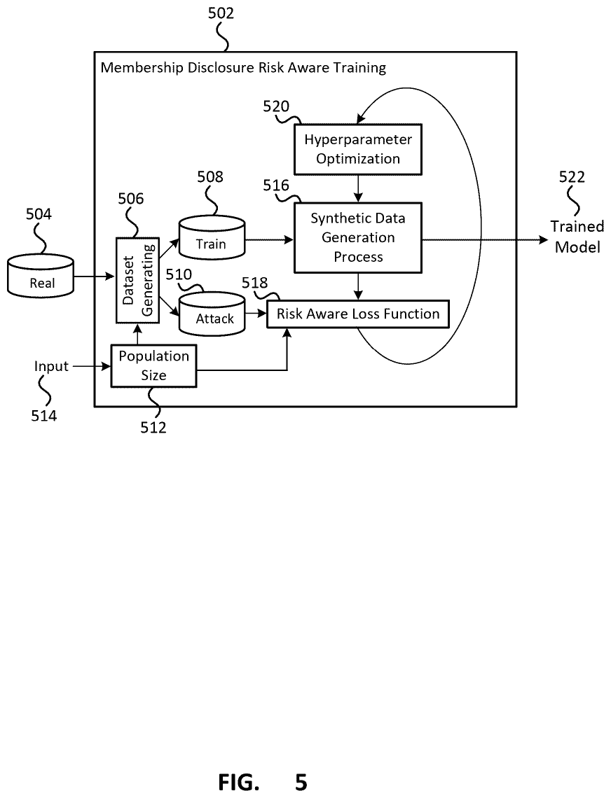

FIG. 5 depicts components for training a synthetic data generation model in a membership disclosure risk aware process. Although not depicted in FIG. 5, the membership disclosure risk aware training functionality 502 may be implemented on one or more computing devices similar to that depicted in FIG. 3. The membership disclosure risk aware training functionality 502 receives a real dataset 504 and dataset generation functionality 506 generates training dataset 508 and an attack dataset 510 using a population size based partitioning fraction of t=n/N. The population size 512 may be provided from a user input 514 or based on other estimation techniques such as based on populations of other similar datasets or studies.

The training functionality is used to train a synthetic data generation process model 516 in an iterative training process. The training may use a risk aware loss function in training the model. The loss function may be used in a hyperparameter optimization process that can adjust the hyperparameters of the synthetic data generation process model based on the loss function. Once the model is sufficiently trained, the trained model 522 can be output and used to generate a synthetic dataset.

It may be possible to ensure that the membership disclosure risk is acceptably small by incorporating the M metric in a risk-utility loss during hyperparameter tuning of the generative model while it is being trained. The following loss metric can be used:

$${loss}_{RU} = - max ( [ M > 0.2 ] \times ( 0.31 + \frac{1}{1 + {e}^{( M - 1 )}} ) , [ M \leq 0.2 ] ) \times U , \qquad ( 7 )$$

In the loss function, U is a utility metric and [ . . . ] are Iverson brackets. This loss proportionally penalizes the utility metric U if the membership disclosure is above the 0.2 threshold using a sigmoid function. If the risk is at or below 0.2, then the loss is equal to the utility since in that case the risk is deemed acceptable. If the risk is slightly above the 0.2 threshold then the loss is almost equal to the utility, and starts to decrease monotonically as the risk grows. The advantage of loss_{RU} is that privacy considerations are integrated within model development rather than being a post-hoc assessment.

The above has described the membership disclosure risk assessment having a more reliable partitioning fraction of t=n/N being incorporated into systems and methods for generating synthetic data as well as training a synthetic data generation model. The more reliable membership disclosure risk assessment described above may also be incorporated into a system for evaluating a membership disclosure of already generated synthetic data. By incorporating the more reliable partitioning fraction into the synthetic data systems, synthetic data that meets a privacy threshold can more readily and reliably be generated, which can mean less processing time required for a computing system to generate the synthetic data. Since the privacy characteristics of the synthetic data can be more accurately evaluated, the synthetic dataset can be generated with less trial and error to achieve a desired privacy threshold. Further, the incorporation of the more reliable partitioning fraction helps provide a more accurate analysis of the privacy characteristics and as such can allow the computing systems used to generate the synthetic data to generate synthetic datasets that may have higher utility while still meeting privacy requirements.

It will be appreciated by one of ordinary skill in the art that the system and components shown in FIGS. 1-9 can include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method for use in providing a synthetic dataset comprising:
receiving at a computing device a real dataset comprising a plurality (n) of records from a population having an estimated population size of N;
splitting the real dataset into a training dataset and a holdout dataset;
generating an attack dataset by combining
$$m \times \frac{n}{N}$$
records from the training dataset and
$$m \times ( 1 - \frac{n}{N} )$$
records from the hold out dataset;
generating a synthetic dataset from the training dataset using a synthetic data generation process;
determining a number of matching records in the attack dataset that match a record in the synthetic dataset;
determining a membership disclosure risk score based on the number of matching records; and
providing an output at the computing device based on the membership disclosure risk score when the membership disclosure risk score indicates an acceptable level of risk.

2. The method of claim 1, further comprising tuning one or more hyperparameters of the synthetic data generation process when the membership disclosure risk score indicates an unacceptable level of risk.

3. The method of claim 1, wherein the membership disclosure risk score is based on an F1 score.

4. The method of claim 3, wherein the membership disclosure risk is an M score determined according to:
$$M = \frac{F - {F}_{max}}{1 - {F}_{max}} ,$$
where F is the F1 score; and
Fₘₐₓ is a maximum F1 score.

5. The method of claim 4, wherein Fₘₐₓ is determined according to:
$${F}_{max} = \frac{2 \times n / N}{1 + n / N} .$$

6. The method of claim 5, wherein the M score is used in a loss function for training a model used in the synthetic data generation process.

7. The method of claim 6, wherein the loss function is determined according to:
$${loss}_{RU} = - max ( [ M > 0.2 ] \times ( 0.31 + \frac{1}{1 + {e}^{( M - 1 )}} ) , [ M \leq 0.2 ] ) \times U ,$$
wherein, U is a utility metric and [ . . . ] are Iverson brackets.

8. The method of claim 7, wherein the output comprises the trained model used in the synthetic data generation process.

9. The method of claim 5, wherein an M score of M≤0.2 is used as the membership disclosure risk score that indicates the acceptable level of risk.

10. The method of claim 9, wherein the output comprises an output dataset generated by the synthetic data generation process.

11. The method of claim 10, wherein the output dataset comprises the synthetic dataset generated from the training dataset.

12. The method of claim 10, wherein the output dataset comprises a dataset generated by the synthetic data generation process from the real dataset.

13. The method of claim 1, wherein determining the number of matching records in the attack dataset that match records in the synthetic dataset comprises comparing each record in the attack dataset to each record in the synthetic dataset to determine if there is a match.

14. The method of claim 13, wherein a match is determined if a distance between records is less than a matching distance threshold.

15. A system for use in providing a synthetic dataset comprising:
a processor for executing instructions; and
a memory storing instructions which when executed by the processor configure the system to provide a method comprising:
receiving at a computing device a real dataset comprising a plurality (n) of records from a population having an estimated population size of N;
splitting the real dataset into a training dataset and a holdout dataset;
generating an attack dataset by combining
$$m \times \frac{n}{N}$$
records from the training dataset and
$$m \times ( 1 - \frac{n}{N} )$$
records from the hold out dataset;
generating a synthetic dataset from the training dataset using a synthetic data generation process;
determining a number of matching records in the attack dataset that match a record in the synthetic dataset;
determining a membership disclosure risk score based on the number of matching records; and
providing an output at the computing device based on the membership disclosure risk score when the membership disclosure risk score indicates an acceptable level of risk.

16. The system of claim 15, wherein the method configured by execution of the instructions further comprises tuning one or more hyperparameters of the synthetic data generation process when the membership disclosure risk score indicates an unacceptable level of risk.

17. The system of claim 15, wherein the membership disclosure risk score is based on an F1 score.

18. The system of claim 17, wherein the membership disclosure risk is an M score determined according to:
$$M = \frac{F - {F}_{max}}{1 - {F}_{max}} ,$$
where F is the F1 score; and
Fₘₐₓ is a maximum F1 score.
The method of claim 4, wherein Fₘₐₓ is determined according to:
$${F}_{max} = \frac{2 \times n / N}{1 + n / N} .$$

19. The system of claim 18, wherein the M score is used in a loss function for training a model used in the synthetic data generation process.

20. A non-transitory computer readable memory storing instructions which when executed by a processor configure a computing device to provide a method comprising:
receiving at a computing device a real dataset comprising a plurality (n) of records from a population having an estimated population size of N;
splitting the real dataset into a training dataset and a holdout dataset;
generating an attack dataset by combining
$$m \times \frac{n}{N}$$
records from the training dataset and
$$m \times ( 1 - \frac{n}{N} )$$
records from the hold out dataset;
generating a synthetic dataset from the training dataset using a synthetic data generation process;
determining a number of matching records in the attack dataset that match a record in the synthetic dataset;
determining a membership disclosure risk score based on the number of matching records; and
providing an output at the computing device based on the membership disclosure risk score when the membership disclosure risk score indicates an acceptable level of risk.
